(19) United States
(12) Patent Application Publication
(10) Pub. No.: US 2016/0062754 A1
(43) Pub. Date: Mar. 3, 2016

(54) Coordinating Application Deployment with a Platform Tier

(71) Applicant: HEWLETT-PACKARD DEVELOPMENT COMPANY, L.P., Houston, TX (US)

(72) Inventors: Travis S. Tripp, Ft. Collins, CO (US); Kevin Lee Wilson, Ft. Collins, CO (US); Joseph Paul Reves, Ft. Collins, CO (US)

(21) Appl. No.: 14/783,524

(22) PCT Filed: Apr. 30, 2013
(86) PCT No.: PCT/US2013/038857

§ 371 Date: Oct. 9, 2015

(51) Int. Cl. G06F 9/445; G06F 9/44

(52) U.S. Cl. CPC G06F 8/60; G06F 8/70

(57) ABSTRACT

Coordinating application deployment with a platform tier includes assigning a platform tier that has at least some capabilities that match application requests specific to an application embodied in an application layer, deploying the application to the platform tier, and performing a development task on the application in the platform tier with the capabilities.

### BACKGROUND

Application development is the development of an application product in a planned and structured process. Stages of development may include conceptualization, developing program instructions to execute the function of the application, quality assurance, and production. Different approaches to application development devote different amounts of resources to each of these stages. Further, different approaches to application development may include more or less stages than those mentioned above. The development of an application may take a rigidly structured approach or the approach may be more flexible where portions of the application are developed piece by piece until the application is ready for use.

### BRIEF DESCRIPTION OF THE DRAWINGS

The accompanying drawings illustrate various examples of the principles described herein and are a part of the specification. The illustrated examples are merely examples and do not limit the scope of the claims.

FIG. 1 is a diagram of an example of a coordinating system on a network according to the principles described herein.

FIG. 2 is a diagram of an example of deploying an application to a platform tier according to the principles described herein.

FIG. 3 is a diagram of an example of a capabilities library according to the principles described herein.

FIG. 4 is a diagram of an example of a method for developing an application with a platform tier according to the principles described herein.

FIG. 5 is a diagram of an example of a coordinating system according to the principles described herein.

FIG. 6 is a diagram of an example of a coordinating system according to the principles described herein.

FIG. 7 is a diagram of an example of a flowchart of a process for developing an application with a platform tier according to the principles described herein.

### DETAILED DESCRIPTION

Often, different development products are used at different stages of application development. These different products can use different hardware, operating systems, middleware, and other programs. As a result, the application may be rewritten multiple times to accommodate the differences in the development products used at each of these stages. The principles described herein include mechanisms for developing applications such that the various stages use consistent resources that reduce or eliminate the number of times that the application's code is rewritten to accommodate the products used during different development stages. In accordance with the principles described herein, the application developers can describe their application and its dependencies such as operating system, hardware parameters, middleware, and so forth before the applications are deployed to the next stage of development. By defining the definitions and application's parameters beforehand, development environments for each stage can be developed to accommodate these definitions and parameters. Thus, the developers can transition from one stage of development to the next stage without duplicating the application with just minor differences. As a result, the application development process is simplified and reduced.

These principles include a method for developing applications with a platform tier. Such a method includes assigning a platform tier that has at least some capabilities that match application requests specific to an application embodied in an application layer, deploying the application to the platform tier, and performing a development task on the application in the platform tier with the capabilities.

In the following description, for purposes of explanation, numerous specific details are set forth in order to provide a thorough understanding of the present systems and methods. It will be apparent, however, to one skilled in the art that the present apparatus, systems, and methods may be practiced without these specific details. Reference in the specification to “an example” or similar language means that a particular feature, structure, or characteristic described is included in at least that one example, but not necessarily in other examples.

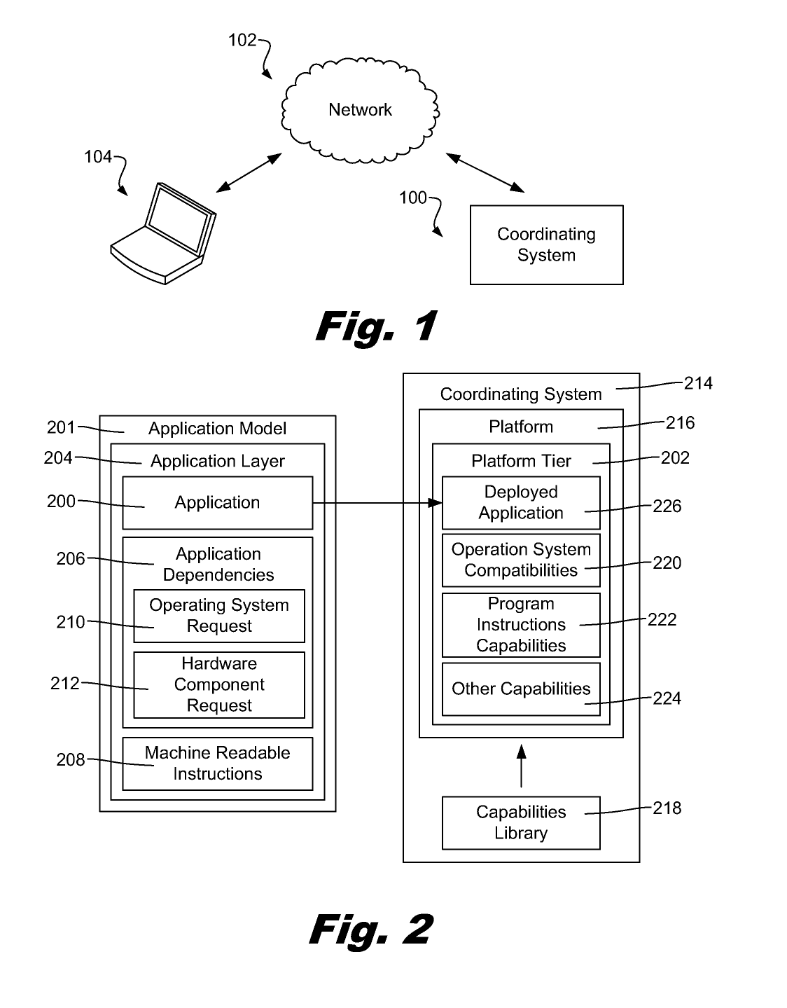

FIG. 1 is a diagram of an example of a coordinating system (100) on a network according to the principles described herein. In this example, a client device (104) is in communication with the network (102) that is in communication with the coordinating system (100).

The client device (104) may be any appropriate device that a user can use to communicate with the coordinating system (100). For example, the client device (104) may be a laptop, a personal computer, a desktop, a phone, an electronic tablet, an electronic device, another type of client device, or combinations thereof.

The user may send requests to the coordinating system (100) concerning an application that is at some stage of development. These requests may include the application's dependencies, such as the operating system with which the application is currently compatible, the programs with which the application is currently compatible, the hardware and middleware with which the application is currently compatible, and so forth. The requests may also include development tasks and/or actions desired to be performed on the application with the coordinating system (100). Further, the requests may include hierarchy information, traversal order information, value information, property information, other types of information, or combinations thereof.

The coordinating system (100) includes at least one platform. The platforms include one or multiple tiers. Each tier is made of a group of servers that can be set up to use a common operating system and/or common programs. The requests sent to the coordinating system (100) are compared to the existing capabilities of the platform tiers of the coordinating system (100). If a platform tier already has the capabilities that will satisfy the application's requests, the application is assigned to that platform tier. If none of the platform tiers currently have the capabilities to satisfy the application's requests, one of the platform tiers is selected to be assigned to the application. The capabilities that the platform tier lacks are applied to the platform tier from resources available to the coordinating system (100). In some examples, the resources are contained within the coordinating system (100), such as in a capabilities library. In other examples, the capabilities are available to the coordinating system (100) over a network connection.

The coordinating system (100) can track capabilities of each of the platform tiers with identification tags. Each of the capabilities requested by the user can be associated with an identification tag in the capabilities library. Thus, in response to obtaining requests about an application from the user, the coordinating system (100) can search for the tags in the platform tiers that match the individual requests for the application.

In other examples, the coordinating system can offer the capabilities of the platform tiers to the user through the client device (104). In such an example, the user can determine which of the platform tiers matches or at least partially matches the application. In yet other examples, a program available to the client device (104) determines on the user's behalf which of the platform tiers matches or at least partially matches the application's requests.

In response to assigning the application to a platform tier, the application is deployed to the platform tier. The deployed application can be furthered developed on the platform as desired by the user. The principles described herein allow the user to focus on developing the application's structure without having to reformat the application for the next stage of development. By determining what the application can use in further stages of development, the platform tier is customized to fit the parameters of the application instead of the application having to change to fit the conditions of the platform. Thus, creating multiple version of the application can be avoided. Further, later stages of development can also use the platform tier, which already contains the capabilities requested for the application. Thus, the entire development stage is streamlined to reduce and/or eliminate the redundancy of reformatting the application to fit the conditions of different development products used in later development stages that are not fully compatible with the products of the earlier stages of the application's development.

FIG. 2 is a diagram of an example of deploying an application (200) to a platform tier (202) according to the principles described herein. In this example, an application model (201) has an application (200) embodied in an application layer (204). The application layer (204) also includes application dependencies (206) and machine readable instructions (208) related to the application (200). The application's dependencies (206) may include requests, such as operating system requests (210) and hardware component requests (212). While not depicted in the example of FIG. 2, other dependencies may be included. For example, the application layer (204) may include hierarchy requests, value requests, property requests, traversal order requests, action model requests, other types of requests, or combinations thereof. The coordinating system (214) includes a platform (216) and at least one platform tier (202). The platform tier (202) has operating system capabilities (220), program instruction capabilities (222), and other capabilities (224). Further, in response to the coordinating system (214) assigning the application to the platform tier (202), the application (200) from the application layer (204) is deployed to the platform tier (202) to create a deployed application (226). Further, the platform tier (202) is in communications with a capabilities library (218) that can identify and apply capabilities to the platform tier (202).

According to the principles described herein the application model (201) describes logical installation and configuration units of the application (200). The configuration units are called layers. While the example of FIG. 2 includes just an application layer (204), the application model (201) may include additional layers, such as a web layer or a database layer. The layers are managed through operations defined on them, such as deploy operations, undeploy operations, start operations, stop operations, and so forth. Each of these layers can define their dependencies, such as hardware compatibilities, operating system compatibilities, middleware compatibilities, other compatibilities, or combinations thereof. The application model (201) also describes the basic connectivity information between layers and with external services.

The platform (216) describes ways to create a deployment environment that is compatible with one or multiple applications from the application model (201). The platform (216) is composed of one or multiple tiers. A tier is a group of one or multiple servers that provides the same operating system and program instructions. The servers and program instructions of the tier also reside in a common network configuration. Each tier describes the capabilities that it provides. The capabilities may come from the underlying infrastructure or may be deployed after infrastructure provisioning.

When the user wants to model a deployment, the user can create a deployment topology to deploy the application (200) to a platform whose tiers provide the dependencies that their application layers request. The application layer (204) may also attach workload policies, monitoring policies, and other policies to the deployed application (226) and the platform tier (202). This topology model represents one possible way to achieve the deployment of an application.

The user has an ability to apply common deployment capabilities to the platform via developments products like Chef. Chef is a configuration management tool which was developed by Opscode, Inc. located in Seattle Wash., United States. Applying the deployment capabilities allows the application deployment models to concentrate on the structure of the model's layers and the inputs of each deployment. Such a mechanism does not directly bind the application (200) to any specific topology or platform, which gives the user additional freedom to develop the application with fewer restrictions without having to create redundant versions of the application at later stages of development.

Applying capabilities can be accomplished through tagging. Each of the capabilities may be associated with a tag. Thus, the capabilities identified as lacking in the platform tier can be invoked by calling the appropriate tag. Applying the capabilities may include downloading the capabilities to the platform tier. In other examples, applying the capabilities includes making the capabilities accessible to the platform tier through a network connection.

A capability is written in an open metadata definition language and includes information or functionality that can satisfy potential requests from application layers. In some cases, the capability may include hierarchy capabilities. For example, Ubuntu is an operating system available through Canonical, LTD that is headquartered in London, United Kingdom. A hierarchy capability may provide information to instruct the deployed application that Ubuntu can inherit from Linux, which is another operating system that is available through multiple vendors through the open general public license of the Free Software Foundation located in Boston, Mass. Also, the capability may be a traversal capability. For example, the capability may include information that indicates that Java 6, which is a Java platform, comes before Java 7, a later version of the Java platform. The capability may also be a value. For example, the capability may be a value stored in memory. The capability may have available properties, such as installation directories or other types of directories. Further, the capabilities may include action models that can perform the requested actions from the application layer. For example, the action models may include deploy models, reconfiguration models, other types of models, or combinations thereof. Some capabilities may be a way to tag metadata on the object and some may have advanced functionality.

While this example has been described with reference to specific types of capabilities and specific examples of these types of capabilities, the capabilities library (218) can have any appropriate number or any appropriate type of capabilities in accordance with the principles described herein. Further, within the types of capabilities, any appropriate iteration of capabilities may be used in accordance with the principles described herein. In some examples, the capabilities library (218) can be modified by users who have the appropriate administrative privileges.

Many model objects in either the application model or the coordinating system may specify the capabilities that they desire or already provide. For example, the application layer (204) can define the capability that it will request. Likewise, the platform tier (202) can describe the capabilities it already possesses.

The platform tier (202) may enter into an implementation contract with the application layer (204) to be allowed to possess a capability. Thus, the platform tier (202) may be obligated to the application layer (204) to provide the capabilities in response to receiving a request from the capabilities library (218). For example, a virtual machine image may have Windows 8 as the operating system. In such as example, a platform tier based on this virtual machine image will inherit the capability of Windows 8 and the corresponding tag can be used for searching and matching. In another example, the capability tag may be created for Java 7 which includes a property of JAVA_HOME. In response to a platform tier being set up to include Java 7, the platform tier will also provide the value for JAVA_HOME to satisfy the contract regardless of whether Java 7 is in the virtual machine image or Java 7 is actually deployed. In yet another example, some capabilities provide the functionality to perform an action. For example, a capability may include a deployment action model. Such a model can include an ability to receive inputs from an enterprise archive (EAR) file.

In some example, capabilities may be deployable in different environments. For example, a deployment action capability can be implemented by a Database and Middleware Automation (DMA) solution packs available through the Hewlett-Packard company headquartered in Palo Alto, Calif., United States in one environment and by Chef in another environment. Further, the tags associated with the capabilities can be used multiple times and in combinations within the same environment or across different environments. For example, the tags can indicate two versions of Java or can indicate multiple application server process instances.

The capability that corresponds to its requests will affect the applications in many different ways. For example, the capabilities filter out the platform tiers to which the application will be deployed. Also, the application layer will be able to reference and use the capabilities it has requested within the platform tier without being bound to that particular platform or deployment environment. For example, if an application requests JAVA_HOME for a script that the deployed application can execute, the deployed application will be able to reference the JAVA_HOME property from the Java 7 capability as soon as application layer requests the JAVA_HOME property on Java 7. The contract guarantees that at runtime, regardless of the platform and infrastructure to which the application is deployed, the property of JAVA_HOME will have the correct value and the deployed application will be given to the script.

Further, the application layer (204) can depend on a capability with actions. For example, an application model (201) may have an application server layer and a database layer. In other examples, the application layer (204) may request a server clustering capability from a specific vendor. Rather than the application layer (204) including all the tasks for deploying to that specific vendor and rather than the application layer (204) directly binding to a deployment tool (e.g. Chef), the application layer (204) will be able to virtually use the deploy action on the server clustering capability from that specific vendor. The inputs for this virtual action may include some configuration parameters and an EAR file. The user is able to select the program artifact from the application definition to use as the input. At the deployment time, the application can perform late binding and invoke the implementation based on the platform to which it is deployed. One environment may have a platform that is managed via Chef and another environment is managed via the Hewlett-Packard Company's DMA solution pack.

While this example has been described with reference to specific abilities and types of capabilities, any appropriate ability or type of capability may be used in accordance with the principles described herein. Further, while the examples above have been described with reference to specific vendors to provide the capabilities, any appropriate vendor may be used in accordance with the principles described herein. Also, while this example has been described with reference to specific capability sources, like a capabilities library, any appropriate source for the capabilities may be used. For examples, the platform tier may obtain capabilities over a network connection, another server on the network, directly from the vendors, other sources, or combinations thereof.

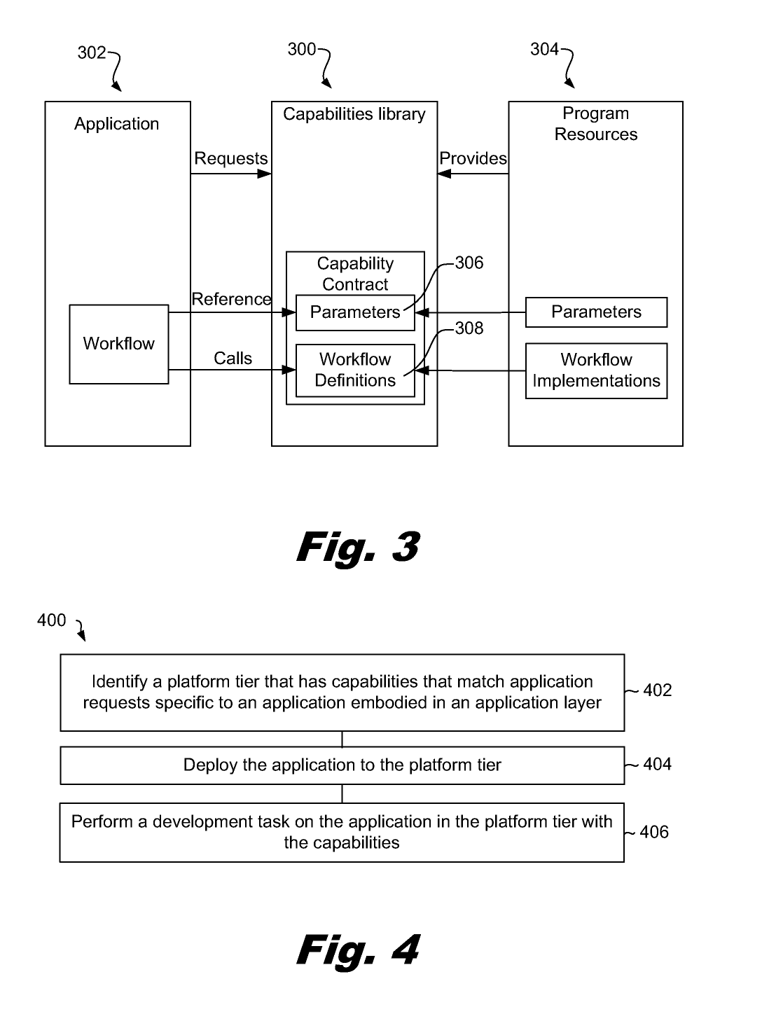

FIG. 3 is a diagram of an example of a capabilities library (300) according to the principles described herein. In this example, the capabilities library (300) includes capabilities is in communication with the application (302) and program resources (304).

By referencing the capability library (300), the application (302) can make use of the parameters (306) of the capability and make calls to the workflows (308) of the capabilities without having a dependency on the program resources (304). The application's requests are to be satisfied at the time the application (302) is deployed. The program resources (304) can be queried to find implementations of the capabilities that will satisfy the application's requests. The program resources (304) can provide the implementations of the capabilities that satisfy the application's requests to the capabilities library (300) where the platform tier has access to them. At the time that the workflows are implemented, the program resources (304) can provide the parameter values associated with the capability implementations to the application as the application (302) is being run on the platform tier.

The capabilities may be arranged in a hierarchy from generic definitions to more specific definitions. In some instances, the capabilities can inherit the parameters of the workflow definitions from their parent workflows. However, the capabilities may not have workflow definitions that are the same as the parent workflow definitions. Other types of capabilities may include values and properties. While this example has been described with reference to specific types of capabilities contained in the capabilities library, any appropriate capability type may be included in the capabilities library.

FIG. 4 is a diagram of an example of a method (400) for developing an application with a platform tier according to the principles described herein. In this example, the method (400) includes identifying (402) a platform tier that has capabilities that match application requests specific to an application embodied in an application layer, deploying (404) the application to the platform tier, and performing (406) a development task on the application in the platform tier with the capabilities.

The platform tier's capabilities may be identified using tags that are associated with the capabilities. Deploying the application may include sending and installing the application to the platform tier such that the platform tier runs the deployed application. The platform tier may already contain some capabilities and be tagged as having those capabilities. Additional capabilities may be added to the platform tier to satisfy the application's requests.

For example, an application may request memory with twenty five to thirty gigabytes, a disk with greater than two hundred fifty gigabyte, and a specific type of server. A platform tier may already have twenty six gigabyte of memory and a three hundred gigabyte disk. In this example, this platform tier is a partial candidate for the application as long as the specific type of server can be supported on the same platform. Thus, the coordinating system consults the library for resources that provide the capability to operate the specific type of server. The coordinating system may select a candidate resource to support the specific server type. In response to selecting resources that will support the specific type of server, the coordinating system may continue to consult with the library to find additional programs and the like that will provide additional support to the selected resources. Thus, the coordinating system will continues to look for programs, capabilities, resources, and the like until it can satisfy the application's requests.

The applications can be defined with a minimum of requests, and the platforms can also be defined with their capabilities. In such an example, logic can be used to determine which platform tier to use. In some examples, based on the application's requests and the platform tier's capabilities, the coordinating system may determine to build a new platform tier to accommodate the requests of the application.

The development task may be any appropriate task that occurs in a stage of development. For example, the development task may include modeling tasks, reconfiguring tasks, tasks involved with concept development, tasks involved with quality assurance, tasks involved with production, tasks involved with other stages of development, or combinations thereof.

The application can define its own requests. The requests can include requests for an action, a value, a property, a traversal order, a hierarchy, another request, or combinations thereof.

The platform tier may also be able to define its capabilities. The platform tier has at least one server that shares a common operating system and common programs, and the capabilities includes open metadata definition language that describe a hierarchy, a traversal order, a value, a property, an action model, another capability, or combinations thereof.

In response to receiving the requests, a platform tier is identified that matches at least some of the application's requests. The method may include referencing a capability library that associates tags in the platform tier with the capabilities.

If a selected platform tier lacks some of the capabilities requested by the application, the capabilities can be provided by additional programs. For example, the capabilities may be applied from the capabilities library. Applying may include downloading the capabilities to the platform tier. In other examples, applying includes making the capabilities accessible to the platform tier over a network connection. In additional to deploying the application to the platform tier, the application layer may attach additional machine readable instructions that are relevant to the application to the platform tier. The machine readable instructions may be a deployment policy, a maintenance policy, a monitoring policy, another policy, other types of machine readable instructions, or combinations thereof.

In some examples, in response to making requests, the coordinating system will determine the capabilities that are needed in the platform tier to run the application. If no platform tier exists that is suitable to run the application with the platform's existing capabilities, the coordinating system may decide to build a new platform tier and apply the capabilities to satisfy the application's requests. In other examples, the application's requests are matched to a platform tier that can at least have access or receive at least some of the capabilities to satisfy the application's request.

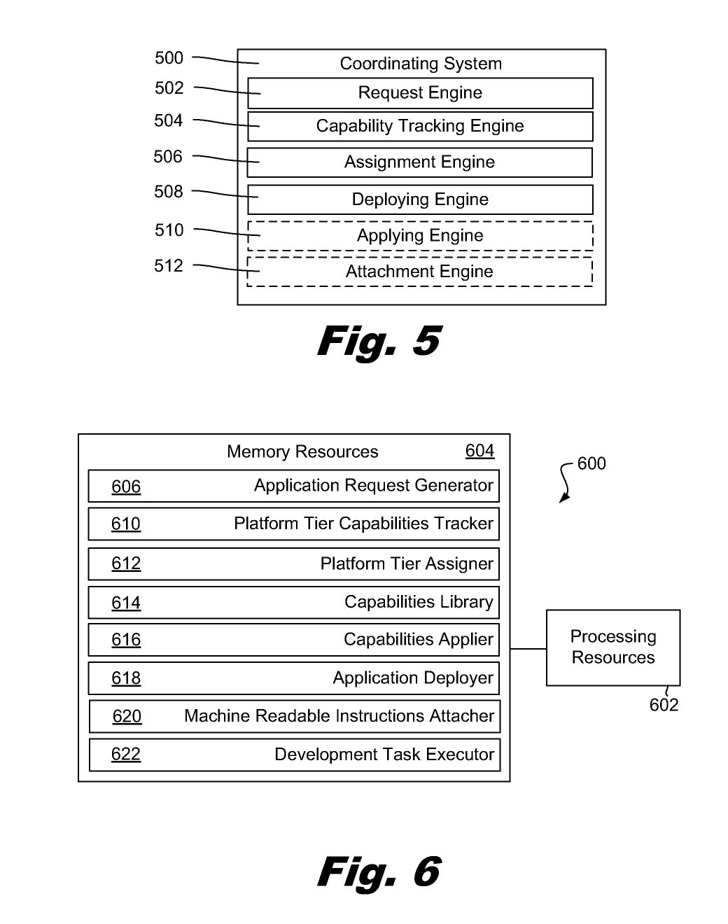

FIG. 5 is a diagram of an example of a coordinating system (500) according to the principles described herein. The coordinating system (500) includes a request engine (502), a capabilities tracking engine (504), an assignment engine (506), and a deploying engine (508). In this example, the coordinating system (500) also includes an applying engine (510) and an attachment engine (512). The engines (502, 504, 506, 508, 510, 512) refer to a combination of hardware and program instructions to perform a designated function. Each of the engines (502, 504, 506, 508, 510, 512) may include a processor and memory. The program instructions are stored in the memory and cause the processor to execute the designated function of the engine.

The request engine (502) causes the application layer to generate requests for dependencies and/or capabilities for the application in later stages of the application's development. The capabilities tracking engine (504) tracks which of the platform tiers include capabilities that satisfy at least some of the application's requests. The assignment engine (506) assigns the application layer to one of the platform tiers. If the assigned platform tier does not include all of the capabilities to satisfy the application's requests, the applying engine (510) applies those capabilities to the assigned platform tier.

The deploying engine (508) deploys the application from the application layer to the platform tier. The attachment engine (512) attaches machine readable instructions concerning the application to the platform tier.

FIG. 6 is a diagram of an example of a coordinating system (600) according to the principles described herein. In this example, the coordinating system (600) includes processing resources (602) that are in communication with memory resources (604). Processing resources (602) include at least one processor and other resources used to process programmed instructions. The memory resources (604) represent generally any memory capable of storing data such as programmed instructions or data structures used by the coordinating system (600). The programmed instructions shown stored in the memory resources (604) include an application request generator (606), a platform tier capabilities tracker (610), a platform tier assigner (612), a capabilities applier (616), an application deployer (618), a machine readable instructions attacher (620), and a development task executor (622). The data structures shown stored in the memory resources (604) include a capabilities library (614).

The memory resources (604) include a computer readable storage medium that contains computer readable program code to cause tasks to be executed by the processing resources (602). The computer readable storage medium may be tangible and/or non-transitory storage medium. The computer readable storage medium may be any appropriate storage medium that is not a transmission storage medium. A non-exhaustive list of computer readable storage medium types includes non-volatile memory, volatile memory, random access memory, memristor based memory, write only memory, flash memory, electrically erasable program read only memory, magnetic storage media, other types of memory, or combinations thereof.

The application request generator (606) represents programmed instructions that, when executed, cause the processing resources (602) to generate requests for the application. The platform tier capabilities tracker (610) represents programmed instructions that, when executed, cause the processing resources (602) to track the capabilities of the platform tiers based on the tags in the capabilities library (614). In some examples, the capabilities of the platform tier are determined manually. However, in other examples, the capabilities of the platform tier are determined with a determination engine. The platform tier assigner (612) represents programmed instructions that, when executed, cause the processing resources (602) to assign a platform tier to the application owning the requests. The capabilities applier (616) represents programmed instructions that, when executed, cause the processing resources (602) to apply capabilities to the assigned platform tier that are lacking to satisfy the application's requests.

The application deployer (618) represents programmed instructions that, when executed, cause the processing resources (602) to deploy the application to the platform tier. The machine readable instructions attacher (620) represents programmed instructions that, when executed, cause the processing resources (602) to attach machine readable instructions concerning the application to the platform tier. The development task executor (622) represents programmed instructions that, when executed, cause the processing resources (602) to execute a development task on the deployed application.

Further, the memory resources (604) may be part of an installation package. In response to installing the installation package, the programmed instructions of the memory resources (604) may be downloaded from the installation package's source, such as a portable medium, a server, a remote network location, another location, or combinations thereof. Portable memory media that are compatible with the principles described herein include DVDs, CDs, flash memory, portable disks, magnetic disks, optical disks, other forms of portable memory, or combinations thereof. In other examples, the program instructions are already installed. Here, the memory resources can include integrated memory such as a hard drive, a solid state hard drive, or the like.

In some examples, the processing resources (602) and the memory resources (604) are located within the same physical component, such as a server, or a network component. The memory resources (604) may be part of the physical component's main memory, caches, registers, non-volatile memory, or elsewhere in the physical component's memory hierarchy. Alternatively, the memory resources (604) may be in communication with the processing resources (602) over a network. Further, the data structures, such as the libraries and may be accessed from a remote location over a network connection while the programmed instructions are located locally. Thus, the coordinating system (600) may be implemented on a user device, on a server, on a collection of servers, or combinations thereof.

The coordinating system (600) of FIG. 6 may be part of a general purpose computer. However, in alternative examples, the coordinating system (600) is part of an application specific integrated circuit.

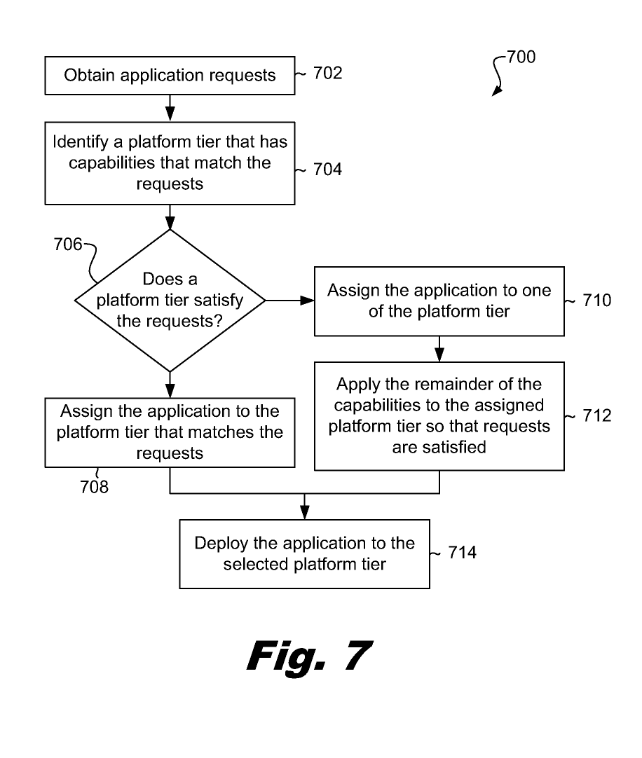

FIG. 7 is a diagram of an example of a flowchart (700) of a process for developing an application with a platform tier according to the principles described herein. In this example, the process includes obtaining (702) application requests and identifying (704) a platform that has capabilities that match the requests. The process also includes determining (706) whether the identified platform tier(s) satisfy the requests. If one of the platform tiers satisfies the requests, the process includes assigning (708) the application to the platform tier that matches the requests. If none of the platform tiers satisfy the requests, the process includes assigning (710) the application to one of the platform tiers and applying (712) the remainder of the capabilities to the assigned platform tier such that the requests are satisfied. The application is deployed (714) to the assigned platform tier.

While the examples above have been described with reference to specific application models and application layers, any appropriate application model or application layer in accordance with the principles described herein may be used. Further, while the examples above have been described with reference to specific platforms and platform arrangements, any appropriate platform or platform arrangement may be used in accordance with the principles described herein. Also, while the examples above have been described with reference to specific platform tiers, any appropriate platform tiers may be used in accordance with the principles described herein.

Further, while the examples above have been described with reference to specific application requests, any appropriate application request may be made in accordance to the principles described herein. Also, while the examples above have been described with reference to specific dependencies and capabilities, any appropriate dependencies or capabilities may be made in accordance to the principles described herein. While the examples above have been described with reference to specific machine readable instructions, any appropriate type of machine readable instructions may be used in accordance with the principles described herein. While the examples above have been described with reference to specific tags and capabilities libraries, any appropriate tags or capabilities libraries may be used in accordance with the principles described herein.

The preceding description has been presented only to illustrate and describe examples of the principles described. This description is not intended to be exhaustive or to limit these principles to any precise form disclosed. Many modifications and variations are possible in light of the above teaching.

What is claimed is:

1. A computer program product for coordinating applications deployment with a platform tier, comprising:
a non-transitory computer readable storage medium, said non-transitory computer readable storage medium comprising computer readable program code embodied therewith, said computer readable program code comprising program instructions that, when executed, causes a processor to:
identify a platform tier that has capabilities that match application requests specific to an application embodied in an application layer;
deploy said application to said platform tier; and
perform a development task on said application in said platform tier with said capabilities.

2. The computer program product of claim 1, further comprising program instructions that, when executed, causes said processor to attach additional machine readable instructions to said platform tier.

3. The computer program product of claim 1, further comprising program instructions that, when executed, causes said processor to build a platform tier to have said capabilities that match said application requests.

4. The computer program product of claim 1, further comprising program instructions that, when executed, causes said processor to match said application requests with said capabilities of said platform tier from a group of platform tiers.

5. The computer program product of claim 1, wherein said capabilities includes language that describes a hierarchy, a traversal order, a value, a property, or combinations thereof.

6. The computer program product of claim 1, wherein said application request includes an action.

7. The computer program product of claim 6, wherein said capabilities of said platform tier includes a model of said action.

8. The computer program product of claim 1, wherein said code further comprises program instructions that, when executed, causes said processor to apply capabilities to said platform tier identified to match said application requests.

9. The computer program product of claim 1, wherein said code further comprises program instructions that, when executed, causes said processor to define capabilities of a platform tier.

10. The computer program product of claim 1, wherein said code further comprises program instructions that, when executed, causes said processor to define application requests.

11. The computer program product of claim 1, wherein said platform tier has at least one server that shares a common operating system and common programs.

12. A system for coordinating applications deployment with a platform tier, comprising:
a request engine to generate at least one request to a platform tier from an application layer;
a capability tracking engine to determine existing capabilities of platform tiers;
an assignment engine to assign an application of said application layer to said platform tier based on said at least one request; and
a deployment engine to deploy said application to said platform tier based on an assignment from said assignment engine.

13. The system of claim 12, further comprising an applying engine to apply additional capabilities to said platform tier to satisfy said at least one request.

14. The system of claim 12, further comprising an attachment engine to attach machine readable instructions to said application in said platform tier.

15. A method for coordinating applications deployment with a platform tier, comprising:
generating application requests of a platform tier from an application layer;
tracking existing capabilities of individual platform tiers;
assigning an application of said application layer to one of said individual platform tiers based on said application requests;
applying additional capabilities to said one of said individual platform tiers to satisfy said application requests; and
deploying said application to said one of said individual platform tiers.
